(19) United States
(12) Patent Application Publication
(10) Pub. No.: US 2025/0290770 A1
(43) Pub. Date: Sep. 18, 2025

(54) THREE-DIMENSIONAL (3D) IMPLICIT SURFACE RECONSTRUCTION FOR DENSE HIGH-DEFINITION (HD) MAPS WITH NEURAL REPRESENTATIONS

(71) Applicant: QUALCOMM Incorporated, San Diego, CA (US)

(72) Inventors: Shihao SHEN, San Diego, CA (US); Varun RAVI KUMAR, San Diego, CA (US); Louis Joseph KEROFSKY, San Diego, CA (US); Senthil Kumar YOGAMANI, Headford (IE)

(21) Appl. No.: 18/605,209

(22) Filed: Mar. 14, 2024

(51) Int. Cl. G01C 21/00; G06T 7/11; G06T 7/50; G06T 7/60; G06T 7/73; G06T 7/90; G06T 19/00; G06V 10/776; G06V 10/82; G06V 20/58; G06V 20/70

(52) U.S. Cl. CPC G01C 21/3848; G06T 7/11; G06T 7/50; G06T 7/60; G06T 7/75; G06T 7/90; G06T 19/00; G06V 10/776; G06V 10/82; G06V 20/58; G06V 20/70; G06T 2207/10028; G06T 2207/20081; G06T 2207/20084; G06T 2207/30252; G06T 2210/12; G06T 2210/21; G06T 2210/56; G06T 2219/004; G06T 2219/2012

(57) ABSTRACT

Certain aspects of the present disclosure provide techniques for generating and utilizing neural implicit surface networks to generate a high-definition map of an environment. Certain techniques include receiving first sensor data comprising a plurality of frames corresponding to a first environment, where the first sensor data is generated from a plurality of sensors and generating, from a first neural implicit surface network, a first high-definition (HD) map comprising labels created from one or more characteristics corresponding to the first environment determined based on the first sensor data.

### INTRODUCTION

### Field of the Disclosure

Aspects of the present disclosure relate to three-dimensional (3D) implicit surface reconstruction for dense high-definition (HD) maps with neural representations, and more particularly to techniques for training and utilizing neural implicit surface networks to implicitly represent a plurality of sub-environments of a global environment.

### DESCRIPTION OF RELATED ART

Autonomous and semi-autonomous systems, such as vehicles and robots, utilize sensor data collected by numerous sensor modalities for perception, localization, and planning operations within an environment. The sensor data collected by the numerous sensor modalities may provide vehicle systems with information about a driving environment, other vehicle systems, and/or the operation of the vehicle itself. To form a comprehensive map of the environment, collection vehicles may traverse through an environment collecting sensor data. For example, point cloud data from LiDAR systems and image data from camera systems may be collected. The image data may be manually labeled or processed with a semantic segmentation model to generate labels for features depicted within the image data. The image data is aligned and fused with the point cloud data to generate a static HD map.

The data available within the static HD map is limited by the performance capabilities of the semantic segmentation model and the sparsity of the point cloud data. Thus, autonomous and/or semi-autonomous operations such as perception, localization, and planning operations within an environment utilizing the static HD map suffer from the low resolution and lack of appearance information. Consequently, there exists a need for further improvements in collecting and unifying (e.g., multi-modal) sensor data to generate dense HD maps for tasks such as perception, localization, and planning by autonomous and/or semi-autonomous systems.

### SUMMARY

One aspect provides a method for generating an HD map. The method includes receiving first sensor data comprising a plurality of frames corresponding to a first environment, wherein the first sensor data is generated from a plurality of sensors; and generating, from a first neural implicit surface network, a first high-definition (HD) map comprising labels created from one or more characteristics corresponding to the first environment determined based on the first sensor data.

Another aspect provides a method for utilizing neural implicit surface networks with an apparatus. The method includes determining a location of a vehicle based on location data from one or more position sensors of the vehicle; selecting a first neural implicit surface network from a plurality of neural implicit surface networks respectively trained to represent a plurality of sub-environments of a global environment, wherein the first neural implicit surface network is trained to represent a first sub-environment of the plurality of sub-environments, the first sub-environment corresponding to the location of the vehicle; generating, from one or more output heads of the first neural implicit surface network, one or more output modalities; and rendering, based on the one or more output modalities, one or more two-dimensional representations of the first sub-environment.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an illustrative global environment having a plurality of illustrative sub-environments.

FIG. 2 depicts an illustrative frame of image data of an example sub-environment of a city street generated by one of the sensors equipped on the map collection vehicle.

FIG. 3 depicts an illustrative frame of point cloud data of an example sub-environment of a city street generated by one of the sensors equipped on the map collection vehicle.

FIG. 4 depicts an illustrative sensor and computing system equipped in a map collection vehicle utilizing one or more trained neural implicit surface networks.

FIG. 5 depicts an illustrative framework of a neural implicit surface network for implicitly represent a plurality of sub-environments of a global environment.

FIG. 6 depicts an illustrative block diagram of an automated annotation review process according to examples of the present disclosure.

FIG. 7 depicts an illustrative block diagram of an example artificial neural network (ANN) according to examples of the present disclosure.

FIG. 8 depicts an example method for generating an HD map.

FIG. 9 depicts an example method for utilizing a neural implicit surface model by an apparatus.

FIG. 10 depicts an example apparatus.

### DETAILED DESCRIPTION

Aspects of the present disclosure provide apparatuses, methods, processing systems, and computer-readable mediums for training and/or utilizing neural implicit surface networks to implicitly represent a plurality of sub-environments of a global environment.

High-definition (HD) maps are highly accurate maps typically used in the field of autonomous driving. HD maps contain details not normally present on traditional maps. For example, HD maps may include elements such as road shape, road markings, traffic signs, barriers, and other non-dynamic objects. HD maps are typically created from sensor data collected by sensors having different perception modalities. The term “different perception modalities” refers to the way in which a sensor perceives and quantifies information within an environment. For example, sensor data is captured using an array of sensors, such as LiDARs, radars, sonars, digital cameras, inertial measurement units (IMUs), GPS, and the like. In some instances, HD maps can include aerial imagery that is used as a reference for constructing the HD map for a sub-environment of a global environment. The term “sub-environment” refers to a portion of an environment defined by either a location or sequence of locations, such as a location on a street or a length of a street (e.g., a city block) within a global environment, such as a city or neighborhood.

The typical process for creating an HD map includes four stages: collecting data from a plurality of sensors, producing a map by fusing the collected data, labeling the produced map and storing the map as an HD map corresponding to a specific sub-environment. The plurality of sensors may have different perception modalities in some cases. In some cases, some sensors may have the same perception modality. A collection vehicle equipped with the plurality of sensors may traverse an environment and record data from each of the plurality of sensors. The collected data is pairwise aligned.

A point cloud dataset is typically one of the datasets generated by one or more of the plurality of sensors, such as LiDAR or radar. The point cloud dataset is used as the base frame for which the collected data from the other sensors is fused. One process for fusing the collected data with the point cloud dataset is referred to as point cloud registration. Through the process of point cloud registration, a three-dimensional model (also referred to as a 3D map) of the entire environment can be constructed. However, the point cloud dataset suffers from low resolution and lack of appearance information. Accordingly, the map labeling stage requires significant processing of images and potentially a vast amount of human effort.

The map labeling stage of typical HD map generation processes includes one or more automated or manual labeling processes. In some instances, one or more neural networks dedicated to different perception tasks are available to produce semantic information. However, these networks do not provide a remedy needed to fill the gap with respect to registering the determined semantics with the point cloud dataset, which is currently remedied by manual labeling.

Some attempts to avoid manual labeling include implementing AI-based processes. These processes either semantically segment the global point cloud directly or predict semantic labels on images first and then project them onto the point cloud. The former approach is prone to errors due to the lack of appearance information in the point cloud, while the latter approach does not leverage the geometry and hence leads to inconsistent semantics especially around object boundaries.

Certain aspects described herein provide a different approach that addresses technical problems of fusing sensor data (e.g., from different modalities) and labeling fused data to generate an HD map by implementing a direct approach that encodes one or more characteristics of the environment (e.g., the geometry, appearance, and semantic information associated with the environment) with a neural implicit surface network to (e.g., implicitly) represent the first environment perceived by the sensor data. The neural implicit surface network may be a neural network such as a multilayer perceptron (MLP). Implicitly representing an environment with the neural implicit surface network may provide a unified solution to encoding richer information in fixed, efficient and manageable memory footprints while providing an alternative solution to dense HD map production, labeling, and rendering that current processes fall short in delivering.

In certain aspects, a collection vehicle equipped with a plurality of sensors (e.g., having different perception modalities) traverses an environment to record and collect sensor data. The sensor data collected by the plurality of sensors may be pairwise aligned and synchronized. At this point, certain aspects of techniques discussed herein may diverge from the current processes.

In certain aspects, the collected sensor data for a sub-environment is fed into the neural implicit surface network to train the neural implicit surface network to implicitly represent the sub-environment that the sensor data corresponds to. Implicit representations discussed herein refer to representations of an environment (e.g., a sub-environment) that are encoded within the neural implicit surface network. Implicit representations differ from discrete representations in that implicit representations are not limited to the resolution of the sensor data collected. That is, discrete representations, such as those generated by current methods are limited to the resolution of the point cloud dataset or similar low-resolution sensor modality. However, implicit representations of an environment learned by the neural implicit surface network can provide queryable information for locations within the environment where discrete values may not have been obtained by the plurality of sensors. For example, sensor data, such as an image may have a resolution of 256 pixels×256 pixels. A neural implicit surface network trained to implicitly represent the image, and optionally other sensor data from different perception modalities, can be queried for pixels values at a 512 pixel×512 pixel resolution because the implicit representation does not treat the encoded information as discrete values but rather as a continuous function that represents the image signal. In other words, a sensed value for a particular feature, such as color, depth, semantic information, or the like, for a particular query location does not need to have been directly sensed by one of the plurality of sensors. Instead, the value can be accurately obtained from the implicit representation of the environment learned by the neural implicit surface network.

Furthermore, implicit representations are capable of directly encoding geometry information, appearance information, and semantic information within the implicit representation. That is, since the neural implicit surface network learns a continuous function for each set of sensor data, the implicit representation can include a dense set of geometric, appearance, and semantic information.

Accordingly, certain aspects of techniques discussed herein for training the neural implicit surface network to implicitly represent a sub-environment based on sensor data from a plurality of sensors (e.g., having different perception modalities) may provide a technical benefit of a dense representation of the sub-environment. In certain aspects, the implicit representation can be queried by one of a plurality of different output layers (e.g., heads) to generate various two-dimensional representations of the sub-environment. Accordingly, certain aspects of techniques discussed herein may provide another technical benefit of flexibility and/or generalization of information that can be obtained from the trained neural implicit surface network. Flexibility refers to the technical benefit of adapting new modalities to the trained neural implicit surface network without modifying the network architecture. Generalization refers to the technical benefit of obtaining information about the sub-environment that may not have been directly perceived or measured by a sensor.

Additionally, as discussed above current processes do not provide an efficient or automatic process for labeling features. In certain aspects, since the neural implicit surface network may be trained to implicitly represent the sub-environment based on a combination of sensor data from a plurality of different perception modalities, semantic information encoded from one modality may be learned as a continuous function for the entire environment and embedded with the geometric and appearance information. As such, HD map production and HD map labeling may be automated. Furthermore, learning to encode semantic information may be achieved with minimal supervision, which may provide the technical benefit of reducing and/or eliminating manual labeling overhead and/or secondary processing of image data to generate semantic labels for training the neural implicit surface network. That is, the neural implicit surface network may leverage partial semantic labels for supervision by learning consistencies between predicted geometry and semantics of the sub-environment. For example, the neural implicit surface network may learn from a first frame of image data that a specific geometry corresponds to a road. Then, in subsequent frames where the same geometry is predicted, that semantic information indicating that it is a road is learned, without needed additional images that correspond to subsequent frames. As used herein, the term “frames” refers to groups of pairwise aligned sensor data for a given time and/or location within an environment.

In certain aspects, the techniques discuss herein may efficiently utilize memory as each neural implicit surface network model may be fixed and bounded, which is more efficient than traditional point cloud representations that grow exponentially with map size and/or LiDAR resolution. Additional technical benefits may include real-time rendering for operations such as localization since the neural implicit surface network may be trained to encode geometry information, appearance information, semantic information, and/or the like of the sub-environment within the implicit representation.

### Environments, Sensor Data, and Map Collection Vehicles for HD Map Production

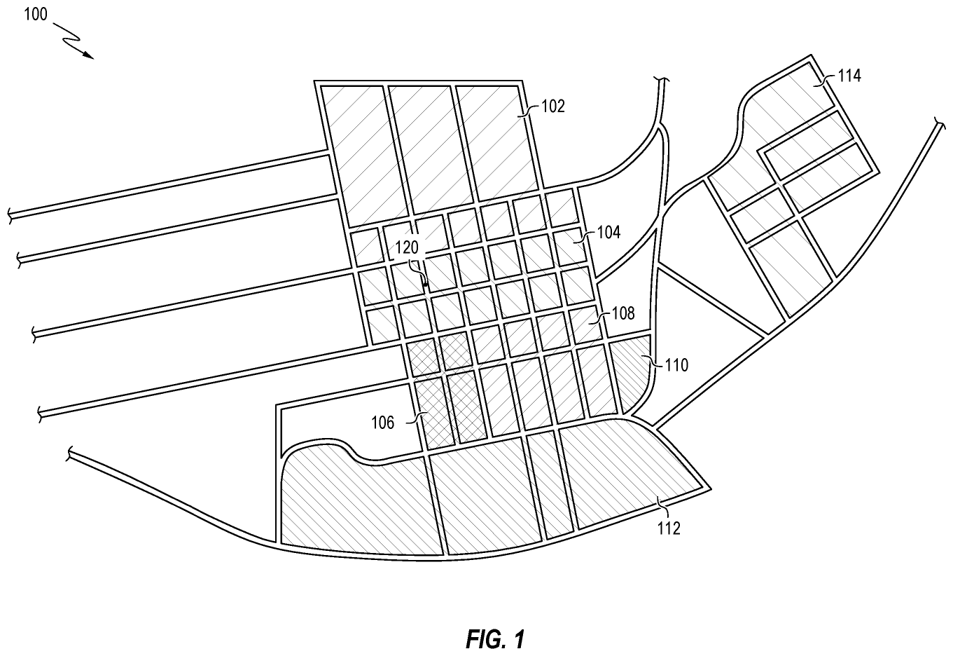

FIG. 1 depicts an illustrative global environment 100 having a plurality of illustrative sub-environments 102, 104, 106, 108, 110, 112, and 114. The global environment may be a city. Each of the sub-environments 102, 104, 106, 108, 110, 112, and 114 may include an area of the city, such as one or more blocks. A map collection vehicle 120 is equipped with a plurality of sensors, such as of different perception modalities. As the map collection vehicle 120 traverses the streets of the city, sensor data from each of the plurality of sensors is collected. The sensor data may be segmented into a plurality of frames where each frame corresponds to a group of pairwise aligned sensor data for a given time and/or location. Additionally, the sensor data may be grouped into sequences that correspond to a sub-environment 102, 104, 106, 108, 110, 112, and 114 of the global environment 100. In this way, a different respective neural implicit surface network can be trained to implicitly represent each sub-environment 102, 104, 106, 108, 110, 112, and 114 of the global environment 100. Once trained, a vehicle that is located within a particular sub-environment 102, 104, 106, 108, 110, 112, and 114 can select the corresponding neural implicit surface network from the plurality of neural implicit surface networks for the global environment 100. The selected neural implicit surface network corresponding to the particular sub-environment 102, 104, 106, 108, 110, 112, and 114 the vehicle is located can be queried and thereby utilized to generate HD map data or directly utilized to obtain information for operations such as perception, localization, or planning. Although certain aspects are described herein with respect to vehicles as devices configured to perform techniques discussed herein, other types of computing devices may similarly be configured to perform any of the techniques discussed herein.

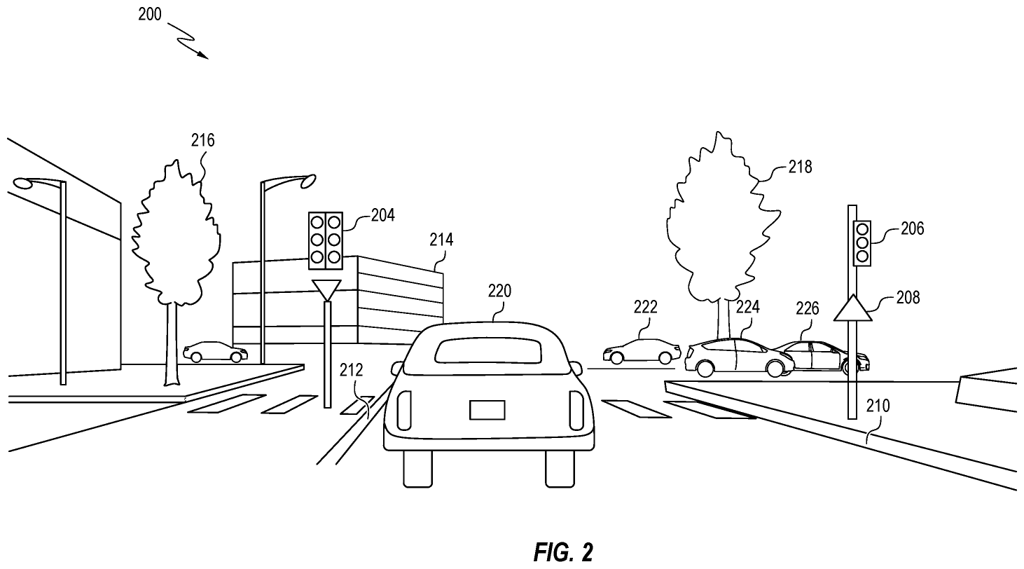

FIG. 2 depicts an illustrative frame of image data 200 of an example sub-environment of a city street generated by one of the sensors equipped on the map collection vehicle 120 (FIG. 1). For example, the map collection vehicle 120 may include one or more cameras configured to capture image data (e.g., video or still images) of the environment as it traverses the streets of the city. For example, the illustrative frame of image data 200 captures non-dynamic features such as signals 204 and 206, signs 208, lane lines 212, buildings 214, curbs and barriers 210, vegetation 216 and 218 and street level markings (e.g., crosswalks, turn arrows, and the like). Dynamic features such as vehicles 220, 222, 224, and 226 are captured in the image data, but may be masked out during a preprocessing step prior to training the neural implicit surface network because these features are not constant within the environment. In some aspects, the image data may be preprocessed to mask out far-field background features as these would not be required for an HD map and may be better quantified by the sensors when nearer to the map collection vehicle 120.

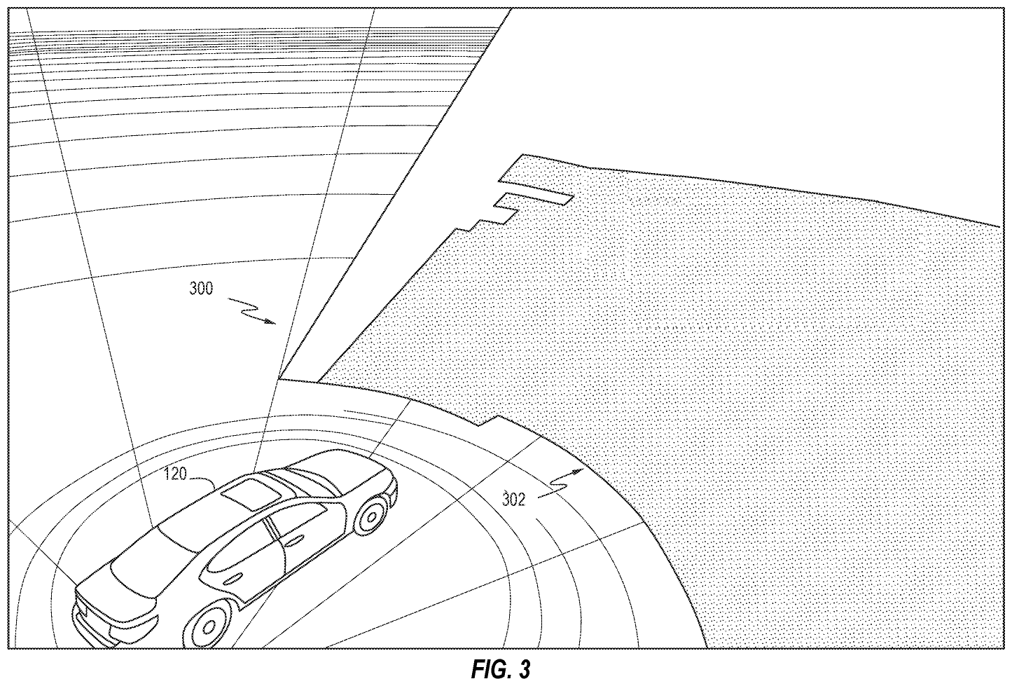

FIG. 3 depicts an illustrative frame of point cloud data 300 of an example sub-environment of a city street generated by one of the sensors equipped on the map collection vehicle 120. LiDARs, radars, sonars or similar sensor systems may collect the point cloud data 300. The point cloud data 300 may be preprocessed to mask out far-field background features as these would not be required for an HD map and may be better quantified by the sensors when nearer to the map collection vehicle 120. For example, only near-field 302 point cloud data may be collected and saved for training the neural implicit surface network to implicitly represent the sub-environment.

FIGS. 2 and 3 provide only two example illustrations of data that may be collected by the map collection vehicle 120. Other sensor data collected by the map collection vehicle 120 may include GPS data, IMU data, depth data, and the like.

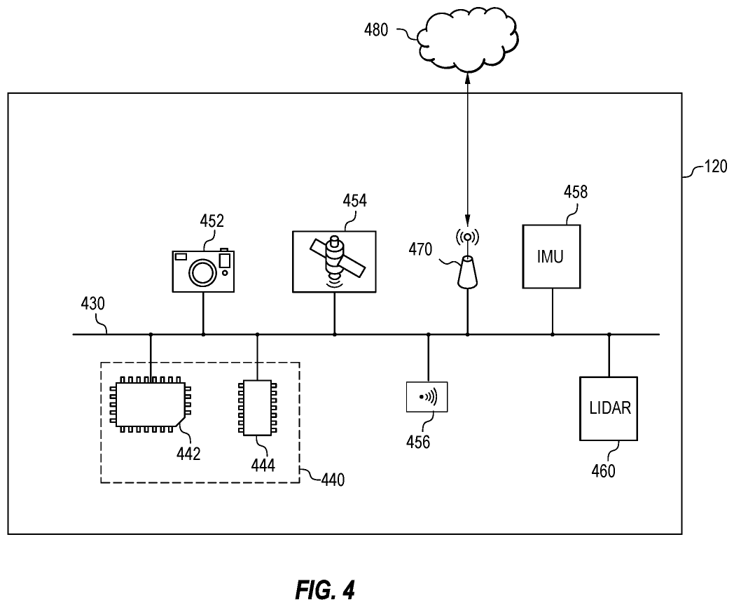

FIG. 4 depicts an illustrative sensor and computing system equipped in a map collection vehicle 120 or other vehicle utilizing one or more trained neural implicit surface networks. The map collection vehicle 120 depicted in FIG. 4 is depicted by way of an example schematic of a vehicle including sensor resources and a computing device. Not every vehicle is required to be equipped with the same set of sensor resources, nor is every vehicle required to be configured with the same set of systems for perceiving attributes of an environment. FIG. 4 only provides one example configuration of sensor resources and systems equipped within a vehicle.

In particular, FIG. 4 provides an example schematic of map collection vehicle 120 including a variety of sensor resources, which may be utilized, by the map collection vehicle 120 to perceive and collect sensor data about the environment. For example, the map collection vehicle 120 may include a computing device 440 comprising one or more processors 442 and a non-transitory computer readable memory 444 (also referred to herein as one or more memories), one or more cameras 452, a global positioning system (GPS) 454, a radar system 456, an IMU 458, a LIDAR system 460, and network interface hardware 470. These and other components of the vehicle may be communicatively connected to each other via a communication path 430.

The communication path 430 may be formed from any medium that is capable of transmitting a signal such as, for example, conductive wires, conductive traces, optical waveguides, or the like. The communication path 430 may also refer to the expanse in which electromagnetic radiation and their corresponding electromagnetic waves traverses. Moreover, the communication path 430 may be formed from a combination of mediums capable of transmitting signals. In one embodiment, the communication path 430 comprises a combination of conductive traces, conductive wires, connectors, and buses that cooperate to permit the transmission of electrical data signals to components such as processors, memories, sensors, input devices, output devices, and communication devices. Accordingly, the communication path 430 may comprise a bus. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. As used herein, the term “communicatively coupled” means that coupled components are capable of exchanging signals with one another such as, for example, electrical signals via conductive medium, electromagnetic signals via air, optical signals via optical waveguides, and the like.

The computing device 440 may be any device or combination of components comprising one or more processors 442 and non-transitory computer readable memory, referred to herein as one or more memories 444. The one or more processors 442 may be any device capable of executing the processor-executable instructions stored in the one or more memories 444. Accordingly, the one or more processors 442 may be an electric controller, an integrated circuit, a microchip, a computer, or any other computing device. The one or more processors 442 are communicatively coupled to the other components of the map collection vehicle 120 by the communication path 430. Accordingly, the communication path 430 may communicatively couple any number of processors 442 with one another, and allow the components coupled to the communication path 430 to operate in a distributed computing environment. Specifically, each of the components may operate as a node that may send and/or receive data.

The one or more memories 444 may comprise RAM, ROM, flash memories, hard drives, or any non-transitory memory device capable of storing processor-executable instructions such that the processor-executable instructions can be accessed and executed by the one or more processors 442. The machine-readable instruction set may comprise logic or algorithm(s) written in any programming language of any generation (e.g., 1GL, 2GL, 3GL, 4GL, or 5GL) such as, for example, machine language that may be directly executed by the one or more processors 442, or assembly language, object-oriented programming (OOP), scripting languages, microcode, etc., that may be compiled or assembled into processor-executable instructions and stored in the one or more memories 444. Alternatively, the processor-executable instructions may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components.

The map collection vehicle 120 may further include one or more cameras 452. The one or more cameras 452 may be any device having an array of sensing devices (e.g., a CCD array or active pixel sensors) capable of detecting radiation in an ultraviolet wavelength band, a visible light wavelength band, or an infrared wavelength band. The one or more cameras 452 may have any resolution. The one or more cameras 452 may be an omni-direction camera or a panoramic camera. In some embodiments, one or more optical components, such as a mirror, fish-eye lens, or any other type of lens may be optically coupled to the one or more cameras 452. The image data collected by the one or more cameras 452 may be stored in the one or more memories 444.

Still referring to FIG. 4, a global positioning system, GPS 454, may be coupled to the communication path 430 and communicatively coupled to the computing device 440 of the map collection vehicle 120. The GPS 454 is capable of generating location information indicative of a location of the map collection vehicle 120 by receiving one or more GPS signals from one or more GPS satellites. The GPS signal communicated to the computing device 440 via the communication path 430 may include location information comprising a National Marine Electronics Association (NMEA) message, a latitude and longitude data set, a street address, a name of a known location based on a location database, or the like. Additionally, the GPS 454 may be interchangeable with any other system capable of generating an output indicative of a location. For example, a local positioning system that provides a location based on cellular signals and broadcast towers or a wireless signal detection device capable of triangulating a location by way of wireless signals received from one or more wireless signal antennas. The sensor data collected by the GPS 454 may be stored in the one or more memories 444.

The map collection vehicle 120 may also include a radar system 456. The radar system 456 measures the distance to objects over wide distances. It is also possible to measure the relative speed of the detected object. The radar system 456 may be a continuous wave (CW), frequency-modulated continuous wave (FMCW), 3D-radar (3D FMCW multiple-input and multiple-output (MIMO)), or 4D-radar (4D FMCW MIMO). The sensor data collected by the radar system 456 may be stored in the one or more memories 444.

The map collection vehicle 120 may include an inertial measurement unit (IMU) 458. The IMU 458 is an electronic device that measures and reports a vehicle's specific force, angular rate, and sometimes the orientation of the vehicle, using a combination of accelerometers, gyroscopes, and sometimes magnetometers. The sensor data collected by the IMU 458 may be stored in the one or more memories 444.

In some aspects, the map collection vehicle 120 may include a LIDAR system 460. The LIDAR system 460 is communicatively coupled to the communication path 430 and the computing device 440. A LIDAR system 460 or light detection and ranging is a system and method of using pulsed laser light to measure distances from the LIDAR system 460 to objects that reflect the pulsed laser light. A LIDAR system 460 may be made as solid-state devices with few or no moving parts, including those configured as optical phased array devices where its prism-like operation permits a wide field-of-view without the weight and size complexities associated with a traditional rotating LIDAR system 460. The LIDAR system 460 is particularly suited to measuring time-of-flight, which in turn can be correlated to distance measurements with objects that are within a field-of-view of the LIDAR system 460. By calculating the difference in return time of the various wavelengths of the pulsed laser light emitted by the LIDAR system 460, a digital 3-D representation of a target or environment may be generated. The pulsed laser light emitted by the LIDAR system 460 include emissions operated in or near the infrared range of the electromagnetic spectrum, for example, having emitted radiation of about 905 nanometers. Sensors such as the LIDAR system 460 can be used by vehicles to provide detailed 3D spatial information for the identification of objects near the map collection vehicle 120, as well as the use of such information in the service of systems for vehicular mapping, navigation and autonomous operations, especially when used in conjunction with geo-referencing devices such as GPS 454 or a gyroscope-based inertial navigation unit (INU, not shown or IMU 458) or related dead-reckoning system. The point cloud data collected by the LIDAR system 460 may be stored in the one or more memories 444.

Still referring to FIG. 4, vehicles are now more commonly equipped with vehicle-to-vehicle communication systems. Some of the systems rely on network interface hardware 470. The network interface hardware 470 may be coupled to the communication path 430 and communicatively coupled to the computing device 440. The network interface hardware 470 may be any device capable of transmitting and/or receiving data with a network 480 or directly with another vehicle equipped with a vehicle-to-vehicle communication system. Accordingly, network interface hardware 470 can include a communication transceiver for sending and/or receiving any wired or wireless communication. For example, the network interface hardware 470 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, network interface hardware 470 includes hardware configured to operate in accordance with the Bluetooth wireless communication protocol. In another embodiment, network interface hardware 470 may include a Bluetooth send/receive module for sending and receiving Bluetooth communications to/from a network 480 and/or another vehicle.

### Framework for Neural Representation of an Environment

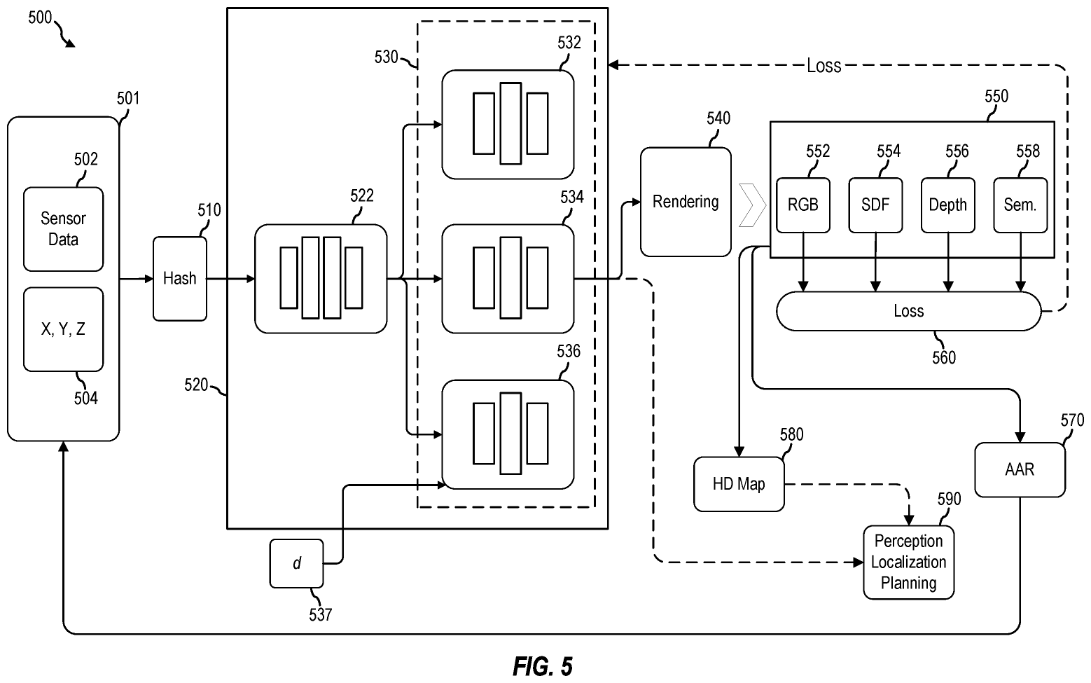

FIG. 5 depicts an illustrative framework 500 of a neural implicit surface network for implicitly represent a plurality of sub-environments of a global environment. The framework 500 depicts a network architecture of the neural implicit surface network configured to encode one or more characteristics of an environment based on sensor data. The one or more characteristics may include one or more of: geometry, appearance, semantics information, or the like. The neural implicit surface network may enable automatic map labeling and rendering of a dense HD map. A neural implicit representation of the environment may be a neural implicit surface network or more generally referred to as a neural network such as a multilayer perceptron (MLP). In certain aspects described herein, neural implicit surface networks are trained for sub-environments of a global environment such that they can be utilized to generate HD maps for each corresponding sub-environment. In certain aspects, the HD maps can be used for autonomous vehicle or robotic operations such as perception, localization, or planning. The framework 500 will be described in the context of implementation by a vehicle, however, this is only one example implementation. The framework 500 may be implemented in any suitable computing device.

As discussed with reference to FIGS. 1-4, sensor data is collected by a map collection vehicle 120 at block 501. The sensor data 502 comprises information such as point cloud data, image data, IMU data, GPS data, and/or the like. In certain aspects, one or more sensors, such as having different perception modalities, collect the sensor data 502. The sensor data 502 may be pairwise aligned and synchronized. For example, the sensor data 502 may include a plurality of frames or units of data that are collected at a particular frequency as a map collection vehicle 120 traverses an environment such as a city street. The sensor data 502 may be a sequence of frames collected at predefined intervals of time as the map collection vehicle traverses the environment.

The sequence may define a unit of time, a distance traveled, or a memory size. For example, a first sensor data may correspond to a predefined number of seconds, minutes, or hours of collected data and a second sensor data may correspond to a subsequent predefined number of seconds, minutes, or hours of collected data. Alternatively, but in a similar manner, a first set senor data may correspond to a predefined distance traveled by the map collection vehicle. In some instances, the first sensor data may correspond to a predefined unit of memory such as 1 gigabyte (GB), 4 GB, 10 GB, 128 GB, 256 GB or the like and the second sensor data may correspond to an additional predefined unit of memory. Each sequence of sensor data may define a sub-environment of a global environment. As such, each sequence of sensor data may be individually used to train a respective neural implicit surface network for the corresponding sub-environment.

The sensor data 502 is fed, for example, frame-by-frame for a sequence of sensor data 502 into a hash block 510 along with an input coordinate 504, for example, each defining an x, y, z position. The hash block 510 carries out a multi-resolution hash encoding process. The hash encoding process may include three steps. In certain aspects, the idea is to map coordinates to trainable feature vectors from sensor data, which can be optimized in the flow of the neural implicit surface network training. The term “feature vector” refers to a vector comprising elements describing an object. For example, a feature vector may include values indicating a position of a feature, such as the positon of a pixel or voxel in space, along with other elements that describe the feature at that position, such as a depth, a color, a semantic value, edge values, a gradient magnitude, grayscale intensity, an area, and/or other quantifiable attributes. Once the elements are defined in a feature vector, multiple feature vectors can then be combined to create a feature space and/or compared numerically for analysis processes. The term “trainable feature vector” refers to a feature vector that can be optimized by, for example, a neural implicit surface network as the network ingests sensor data and learns elements of objects therefrom. Trainable features may be F-dimensional vectors arranged into L grids which contain up to T vectors, where L represents the number of resolutions for features and T represents the number of feature vectors in each hash grid. In certain aspects, in a first step, voxels surrounding the input coordinate 504 are found and the vertices of these grids are hashed. The hashed vertices may be used as keys to look up trainable F-dimensional feature vectors in a second step. In certain aspects, in a third step, based on where the coordinate lies in space, the feature vectors are linearly interpolated to match the input coordinate. The feature vectors from each grid are concatenated, along with any other parameters such as a viewing direction d. The final vector is input into the neural network 520 (e.g., the neural implicit surface network).

In certain aspects, steps 1-3 of the hash encoding process are done independently at a plurality of resolution levels and with respect to sensor data 502 and a plurality of input coordinates 504. Thus, since these feature vectors are trainable, when backpropagating the loss, the loss flows through the neural network 520 and the interpolation function all the way back to the feature vectors. The feature vectors are interpolated relative to the input coordinate 504 such that the neural network 520 can learn a smooth function.

The neural network 520 includes one or more output heads 530. The neural network may be a neural implicit surface model that predicts signed distance to the closest surface of the environment and not the density as in a volumetric radiance model such as NeRF. Such a neural network may be designed to generate a base map for the HD map. If a volumetric representation were used, careful tuning of the density threshold is required, which easily leads to ambiguity and artifacts in the HD map.

In certain aspects, each of the one or more output heads 530 includes a set of layers configured to produce a predefined and different output from other ones of the one or more output heads 530. For example, one of the one or more output heads 530 may be a signed distance head 532. The signed distance head 532 outputs the signed distance to the closest surface, s. Another one of the one or more output heads 530 may be a color head 536 that outputs the color, c, corresponding to a viewing direction, d. Another one of the one or more output heads 530 may be a semantics head 534 that outputs semantic logits, z. Logits refer to the vector of raw, unnormalized output of a layer of a neural network before it undergoes an activation function, such as a softmax activation function. For example, logits are used to compute probabilities of an output class such as semantic segmentation. As such, semantic logits represent a probability value (e.g., from 0 to 1) that a pixel or pixels belongs to a specified class of objects, for example, a person, a road, a sign, an animal, or the like. These are only a few example heads that may be appended to the backbone 522 of the neural network 520, for example a deep MLP, Fθ. The signed distance head 532, Fs, and the semantics head 534,, may be view-invariant shallow MLPs, because the geometry and the semantics of the environment do not depend on where the observer is. On the other hand, the color head 536 Fc may be a shallow MLP that appends the viewing direction, d, to the feature from the backbone 522, in order to generate view-dependent effects, such as reflections. The outputs generated by the one or more output heads 530 are referred to herein as one or more predicted output modalities.

The design of the framework 500 may enable the neural network 520 to leverage the correlation between the geometry and semantics of an environment because places in the environment that have similar shapes are more likely to be the same semantic category. As such, places in the environment having the same geometry, but lacking direct semantic information from sensor data 502, for example, may infer the semantic information for the geometry based on previously learned relationships between geometry and semantic information or vice-a-versa. This may be a benefit over prior techniques that treat geometry reconstruction and semantic segmentation as separate steps in the process of generating an HD map. Accordingly, the framework 500 may provide a unified solution to geometry and semantic information generation through a neural network 520.

The rendering block 540 receives the one or more outputs generated by the one or more output heads 530 of the neural network 520. In order to generate per-pixel information, the rendering process may integrate the one or more predicted output modalities (s, c, z) for all of the sample positions along a camera ray, r, that passes through each pixel to be rendered. The rendering process may utilize a volumetric rendering equation. A few example volumetric rendering equations are discussed herein, but there may be others implemented.

The rendering process renders one or more two-dimensional representations 550 of the environment. Each of the one or more two-dimensional representations 550 comprising respective per-pixel modality information. For example, for rendering a two-dimensional color map (e.g., RGB 552), Equation 1 may be followed.

$$\hat{C} ( r ) = {\sum }_{i = 0}^{N - 1} {T}_{i} {ρ}_{i} {c}_{i} \qquad Eq . 1$$

A two-dimensional SDF map 554 may be obtained directly from output of the signed distance head 532.

For example, for rendering a two-dimensional depth map (e.g., Depth 556), Equation 2 may be followed.

$$\hat{D} ( r ) = {\sum }_{i = 0}^{N - 1} {T}_{i} {ρ}_{i} t \qquad Eq . 2$$

For example, for rendering a two-dimensional semantic map (e.g., Sem. 558), Equation 3 may be followed.

$$\hat{Z} ( r ) = {\sum }_{i = 0}^{N - 1} {T}_{i} {ρ}_{i} {z}_{i} \qquad Eq . 3$$

For Equations 1-3, r=o+td, where o is the camera center, d is the viewing direction of the camera, and t is the depth of the sample position. For Equations 1-3, Tᵢ=Πⱼ₌₀ⁱ⁻¹(1−ρⱼ) is the accumulated transmittance and ρ is the opaque density. For Equations 1-3, Ĉ, \hat{D}, \hat{Z} are the rendered color, depth, and semantic logit of the pixel that r passes through. Finally, \hat{Z} can be transformed into multi-class probabilities by a softmax operation to compute cross-entropy loss for supervision, \hat{p}=softmax(\hat{Z}).

The sampling process may follow the sampling and pruning scheme described in Müller, Thomas, et al. “Instant neural graphics primitives with a multiresolution hash encoding.” ACM Transactions on Graphics (ToG 41.4 (2022): 1 15, which is incorporated herein by reference. The described sampling and pruning scheme is an efficient ray marching based on occupancy information. It is noted that ray marching may only occur when the camera ray intersects non-dynamic objects' surfaces, as dynamic objects are assumed to be masked out before training.

The rendered two-dimensional representations 550 may be use for supervised training of the neural network 520 based on the one or more losses determined by the supervision block 560. The rendered RGB 552, Ĉ, may be supervised using a photometric loss against ground truth, C_{gt}, observed images. For example, the photometric loss may be determined by Equation 4.

$${L}_{photometric} = {\sum }_{r} {‖ \hat{C} ( r ) - {C}_{gt} ( r ) ‖}_{2}^{2} \qquad Eq . 4$$

The rendered SDF map 554 may be supervised using an Eikonal loss adopted to enforce a unit magnitude constraint on gradients of an SDF in the whole space. For example, the Eikonal loss may be determined by Equation 5.

$${L}_{eikonal} = {\sum }_{x} \vert {‖ ∇ \hat{S} ( x ) ‖}_{2} - 1 \vert \qquad Eq . 5$$

The rendered depth 556 may be supervised against LiDAR data (e.g., point cloud data) by projecting the point cloud onto two-dimensional representation(s) of the rendered depth 556 for each LiDAR beam that exists in the sensor data 502. That is, for pixels in the rendered depth 556 that do not directly correspond to a LiDAR beam in the sensor data 502 a loss is not determined. However, for other pixels where a corresponding point cloud data point exists in the sensor data, a loss value is determined and used for supervision (e.g., training) of the neural network 520. For example, the depth loss may be determined by Equation 6.

$${L}_{depth} = {\sum }_{{r}_{LiDAR}} {‖ \hat{D} ( {r}_{LiDAR} ) - {D}_{gt} ( {r}_{LiDAR} ) ‖}_{2}^{2} \qquad Eq . 6$$

The rendered semantic map 558 comprising semantic labels may be supervised against ground truth semantic labels through multi-class cross-entropy loss. For supervision, ground truth semantic labels may not be required to be supplied for every frame and in fact, the model may correctly segment the environment even given a small fraction of labels. That is, since there is a strong correlation between geometry and semantics, the neural network can learn with full geometric supervision but weak semantic supervision. For example, the semantic loss may be determined by Equation 7.

$${L}_{semantic} = {\sum }_{r} [ {\sum }_{i = 1}^{K} {p}^{i} ( r ) log {\hat{p}}^{i} ( r ) ] \qquad Eq . 7$$

K is the number of semantic classes.

In certain aspects, additional regularizations can be added for completeness, such as smoothness loss on the surface, or sparsity loss to impede arbitrary predictions in unobserved regions.

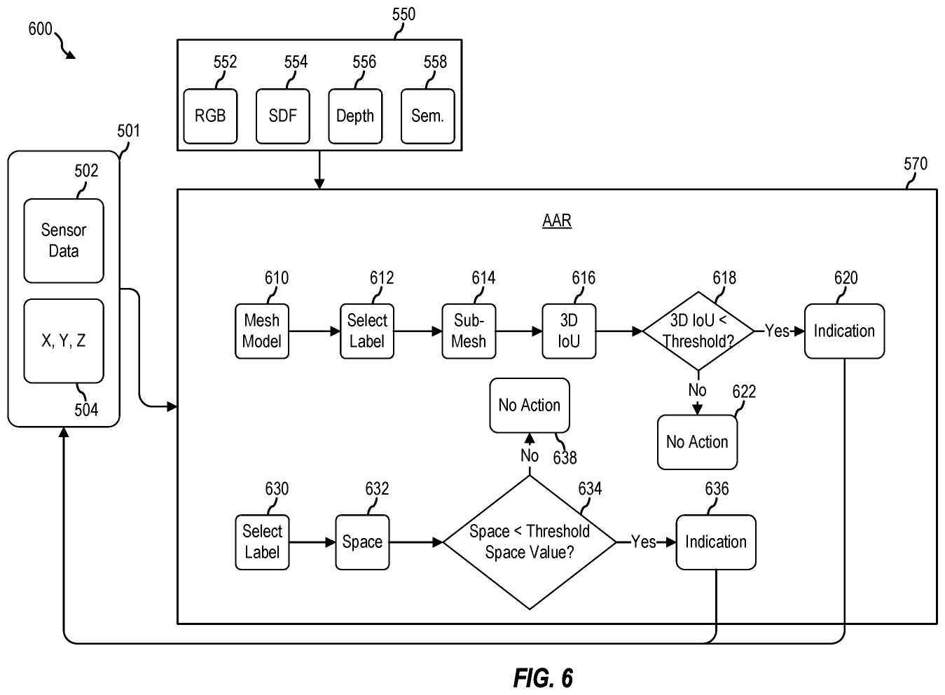

In certain aspects, the framework 500 includes an automated annotation review 570. The framework 500 provides a process for determining the consistency across different modalities based on different metrics. The consistency across modalities like depth, semantics, and SDF can be leveraged to identify low-confidence areas needing better data collection. For example, instead of passing labels, such as semantic labels, to crowd-sourced label verification processes, the framework 500 implements the automated annotation review 570. For implementations where the framework 500 is implemented to complete training of the neural implicit surface network and/or generate the HD map 580 online, for example, directly by a computing device of the map collection vehicle 120 or other vehicle, the automated annotation review 570 enables the framework 500 to provide near-real time feedback on map quality to guide re-collection of sensor data 502 to the map collection vehicle 120. Accordingly, the framework 500 can provide a fully online pipeline for HD map production, eliminating the need for offline processing and significantly improving efficiency. The automated annotation review 570 is discussed in more detail with reference to FIG. 6.

In certain aspects, the framework 500 further includes forming an HD map 580 based on the two-dimensional representations from the neural network 520. The HD map 580 is a highly accurate map typically used in the field of autonomous driving. The HD map 580 contains details not normally present on traditional maps. The HD map 580 may include elements such as road shape, road markings, traffic signs, barriers, and other non-dynamic objects. The HD map may be constructed by map collection, map production, and map labeling processes, for example as depicted and described with reference to FIGS. 5 and 6. As described, map collection processes may include collecting sensor data for use by map production and map labeling processes. Map production may produce a representative map of the environment (e.g., sub-environment) so that map labeling can annotate lanes, road signs, traffic lights, and the like thereon. In certain aspects, map production and map labeling processes may be combined into one process where the map is represented implicitly by one or more neural implicit surface models (e.g., one or more MLPs) and the annotations are inferred automatically as depicted and described with reference to the framework 500 in FIGS. 5 and 6.

The HD map 580 corresponds to a sub-environment from which the sensor data was collected. Furthermore, since the semantic information and geometric information is strongly correlated by the neural network 520, HD map production and HD map labeling is automated.

In some aspects, the framework 500 further includes an operations block 590. The operations block 590 includes one or more operations that a system such as an autonomous or semi-autonomous system for a vehicle may implement. For example, the HD map 580 or the one or more predicted output modalities generated directly by the neural network 520, for example, when queried, may feed into the operations block 590. Here, one or more operations, such as perception, localization, and/or planning may be executed.

The framework 500 enables multiple local implicit models to be trained online, for example, directly on the map collection vehicle 120, without requiring data offloading or centralized processing. Certain aspects of the framework 500, such as the automated annotation review 570, provide the ability for real-time determination of losses during training, which may provide immediate feedback on map quality to guide targeted re-collection, improving data collection efficiency. Implementation of the framework 500 discussed herein further provides a single neural implicit surface model that can unify geometry reconstruction and semantic segmentation thereby avoiding separate steps in traditional pipelines. The rendered outputs from the neural implicit surface model can be used to automatically label the map and review annotations, thus eliminating manual labor requirements. In some aspects, an uncertainty-weighted approach is implemented by the automated annotation review 570 to iteratively refine the map by prioritizing re-collection of highly uncertain regions. The end-to-end online pipeline provided by the framework 500 can be repeated as needed until quality standards are met, thereby improving over batch-oriented traditional workflows.

FIG. 6 depicts an illustrative block diagram of an automated annotation review process according to examples of the present disclosure. More specifically, FIG. 6 illustrates aspects of the automated annotation review 570 introduced in FIG. 5. Accordingly, features depicted and discussed with reference to FIG. 5 are reproduced in FIG. 6 to provide context for discussion of the automated annotation review 570.

As briefly discussed above, the framework 500 may include an automated annotation review 570 for determining the consistency across different modalities based on different metrics to provide near-real time feedback on map quality to guide re-collection of sensor data 502 to the map collection vehicle 120, for example, at block 501. A first metric the automated annotation review 570 may determine is the 3D intersection-over-union (IoU) between 3D bounding boxes and an extracted mesh of an object based on the HD map 580. A second metric the automated annotation review 570 may determine is an occupancy grid that calculates how much space is occupied inside each annotated bounding box. Other metrics the automated annotation review 570 may determine include how consistent the rendered depth, signed distance, and rendered semantics are inside each annotated bounding box.

In aspects where the automated annotation review 570 determines the first metric, starting at block 610, a mesh model is extracted from the neural implicit surface network, which has learned to implicitly represent the environment that the map collection vehicle 120 is traversing. Extraction of the mesh model may include executing a marching cubes algorithm on one or more of the outputs, for example the SDF, generated by the neural implicit surface network. The marching cubes algorithm proceeds through a scalar field, such as an SDF, taking, for example, eight neighbor locations at a time (thus forming an imaginary cube), then determining the polygon(s) needed to represent the object(s) of an isosurface that passes through this cube. The individual polygons are then fused into the desired surface. Other algorithms such as a marching tetrahedral may be used instead of marching cubes.

At block 612, the automated annotation review 570 selects a label from the labels generated by the neural implicit surface network for the HD map 580. The selected label is associated with a bounding box (Bᵢ) for an object (i) in the environment.

At block 614, the automated annotation review 570 generates a candidate bounding box (\hat{B}ₗ) defined by a sub-mesh of the mesh model. The sub-mesh is determined by starting with the bounding box (Bᵢ) as a reference and stepwise adjusting (e.g., expanding or relocating) coordinates defining the bounding box (Bᵢ) within the mesh model in search of the closest sub-mesh that represents the object corresponding to the selected label. The farthest x, y, z positions of the sub-mesh are used to define the candidate bounding box (\hat{B}ᵢ). The coordinates of the sub-mesh indicate the candidate bounding box (\hat{B}ₗ) and the candidate bounding box (\hat{B}ₗ) predicts a location and size of the object (i) in the environment.

At block 616, the automated annotation review 570 calculates a 3D IoU value for the bounding box (Bᵢ) and the candidate bounding box (\hat{B}ₗ). The calculation of the 3D IoU value follows equation 3D

$$IoU = \frac{{B}_{i} ⋂ \hat{{B}_{ι}}}{{B}_{i} ⋃ \hat{{B}_{ι}}} .$$

At block 618, the automated annotation review 570 determines whether the 3D IoU value is less than a predetermined threshold value. If the 3D IoU value is less than a predetermined threshold value, “Yes”, at block 618, the automated annotation review 570 proceeds to block 620. At block 620, the automated annotation review 570 generates an indication based on the 3D IoU value being less than a threshold value. The indication indicates an uncertainty regarding an accuracy of the first label within the first HD map for the object. In certain aspects, the indication includes a location of the object (i) in the environment and is provided to the map collection vehicle 120 to guide re-collection of sensor data pertaining to the object (i). When the map collection vehicle 120 receives the indication the map collection vehicle may begin collecting additional sensor data corresponding to the object (i) based on the location information provided in the indication.

If the 3D IoU value is not less than a predetermined threshold value, “No”, at block 618, the automated annotation review 570 may take no further action or generate an indication that the annotation is verified at block 622.

In aspects where the automated annotation review 570 determines the second metric, the automated annotation review 570, at block 630, similar to block 612, selects a label from the labels generated by the neural implicit surface network for the HD map 580. The selected label is associated with a bounding box (Bᵢ) for an object (i) in the environment.

At block 632, the automated annotation review 570 determines an amount of space occupied within the bounding box (Bᵢ). The amount of space occupied within the bounding box (Bᵢ) may be determined by counting the voxels that are occupied within the bounding box (Bᵢ) as each voxel has a predetermined volume.

At block 634, the automated annotation review 570 determines whether the amount of space is less than a threshold space value. If the amount of space is less than the threshold space value, “Yes”, at block 634, the automated annotation review 570 proceeds to block 636. At block 636, the automated annotation review 570 generates an indication. In certain aspects, the indication includes a location of the object (i) in the environment and is provided to the map collection vehicle 120 to guide re-collection of sensor data pertaining to the object (i). When the map collection vehicle 120 receives the indication the map collection vehicle may begin collecting additional sensor data corresponding to the object (i) based on the location information provided in the indication.

If the amount of space is not less than a predetermined threshold value, “No”, at block 634, the automated annotation review 570 may take no further action or generate an indication that the annotation is verified at block 638.

The first metric and the second metric are only two example metrics the automated annotation review 570 may determine to verify annotations (e.g., to find false positives and false negatives of the annotated bounding boxes for objects in the environment). In certain aspects, distributions of the renderings (e.g., generated by the rendering block 540) within each annotated bounding box (Bᵢ) may be calculated. For example, as previously discussed the renderings may include rendered color Ĉ, rendered depth \hat{D}, rendered semantics \hat{Z}, and/or rendered signed distance field Ŝ. The automated annotation review 570 may calculate and threshold the distribution of rendered depth D and rendered semantics \hat{Z} as extra confidences for the annotation review. Additionally or alternatively, the rendered signed distance field Ŝ may be used by the automated annotation review 570 to determine the surface crossings inside the annotated bounding box (Bᵢ), because if the object is annotated properly, then there may be a surface within the annotated bounding box (Bᵢ).

The framework 500 described herein, including the automated annotation review 570 can be iterated multiple times until the uncertainty within the learned neural implicit surface network is reduced or eliminated in all or most areas of the environment. A technical benefit of implementing the framework 500 may be that no manual efforts may be required and it can be run online on the map collection vehicle 120.

### Example Neural Network Architecture for Neural Representation

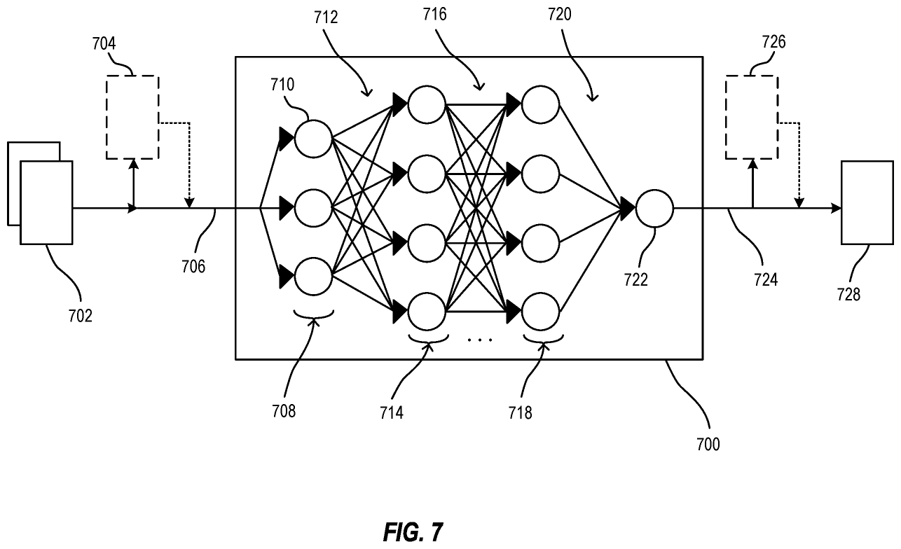

FIG. 7 is an illustrative block diagram of an example artificial neural network (ANN) 700.

The ANN 700 may receive input data 706 which may include one or more bits of data 702, pre-processed data output from the pre-processor 704 (optional), or some combination thereof. Here, the data 702, such as sensor data 502 (FIG. 5) may include training data, verification data, application-related data, or the like, e.g., depending on the stage of development and/or deployment of the ANN 700. A pre-processor 704 may be included within the ANN 700 in some other implementations. The pre-processor 704 may, for example, process all or a portion of data 702, which may result in some of data 702 being changed, replaced, deleted, etc. In some implementations, the pre-processor 704 may add additional data to the data 702.

The ANN 700 includes at least one first layer 708 of artificial neurons 710 to process input data 706 and provide a resulting first layer output data via the edges 712 to at least a portion of at least one second layer 714. The second layer 714 processes data received via the edges 712 and provides a second layer output data via the edges 716 to at least a portion of at least one third layer 718. The third layer 718 processes data received via the edges 716 and provides the third layer output data via the edges 720 to at least a portion of a final layer 722 including one or more neurons to provide output data 724. All or part of the output data 724 may be further processed in some manner by (optional) post-processor 726. Thus, in certain examples, the ANN 700 may provide the output data 728 that is based on the output data 724, post-processed data output from the post-processor 726, or some combination thereof. The post-processor 726 may be included within the ANN 700 in some other implementations. The post-processor 726 may, for example, process all or a portion of the output data 724 which may result in the output data 728 being different, at least in part, to the output data 724, e.g., as result of data being changed, replaced, deleted, etc. In some implementations, the post-processor 726 may be configured to add additional data to the output data 724. In this example, the second layer 714 and the third layer 718 represent intermediate or hidden layers that may be arranged in a hierarchical or other like structure. Although not explicitly shown, there may be one or more further intermediate layers between the second layer 714 and the third layer 718.

The structure and training of artificial neurons 710 in the various layers may be tailored to specific requirements of an application. Within a given layer of an ANN 700, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data 706. Some non-exhaustive example activation functions include a linear function, binary step function, sigmoid, tanh, ReLU and variants, exponential linear unit (ELU), Swish, Softmax, and others.

Design tools (such as computer applications, programs, etc.) may be used to select appropriate structures for the ANN 700 and a number of layers and a number of artificial neurons in each layer, as well as selecting activation functions, a loss function, training processes, etc. Once an initial model has been designed, training of the model may be conducted using training data. Training data may include one or more datasets within which the ANN 700 may detect, determine, identify or ascertain patterns. Training data may represent various types of information, including written, visual, audio, environmental context, operational properties, etc. During training, parameters of the artificial neurons 710 may be changed, such as to minimize or otherwise reduce a loss function or a cost function. A training process may be repeated multiple times to fine-tune the ANN 700 with each iteration.

The ANN 700 or other ML models may be implemented in various types of processing circuits along with memory and applicable instructions therein. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models.

There are a variety of model training techniques and processes that may be used prior to, or at some point following, deployment of an ML model, such as the neural network 520 of FIG. 5.

As part of a model development process, information in the form of applicable training data may be gathered or otherwise created for use in training an ML model accordingly. Once an ML model has been trained with training data, its performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ANN, such as neural network 520 of FIG. 5, parameters affecting the functioning of the artificial neurons and layers may be adjusted. For example, backpropagation techniques may be used to train the ANN by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information.

A transfer learning technique may be used which involves using a pre-trained model as a starting point for training a new model, which may be useful when training data is limited or when there are multiple tasks that are related to each other.

A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training on data distributed across multiple devices or organizations, without the need to centralize data or the training. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ML model to be trained on data collected from a wide range of devices and environments. For example, an ML model may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a model and perform local training on such copy of all or part of the model using locally available training data. Such a device may provide update information (e.g., trainable parameter gradients) regarding the locally trained model to one or more other devices (such as a network entity or a server) where the updates from other-like devices (such as other UEs) may be aggregated and used to provide an update to a shared model or the like. A federated learning process may be repeated iteratively until all or part of a model obtains a satisfactory level of performance. Federated learning may enable devices to protect the privacy and security of local data, while supporting collaboration regarding training and updating of all or part of a shared model.

### Example Operations

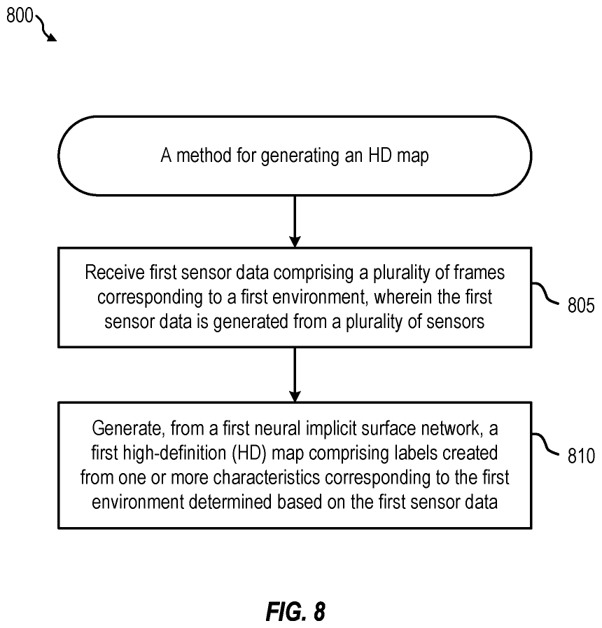

FIG. 8 shows a method 800 for generating an HD map with an apparatus, such as a map collection vehicle 120 of FIGS. 3-4 and 10.

Method 800 begins at block 805 with receiving first sensor data comprising a plurality of frames corresponding to a first environment, wherein the first sensor data is generated from a plurality of sensors. For example, block 805 may be performed by the apparatus, such as a map collection vehicle 120 as described above with reference to FIGS. 3-4 and 10 that is configured to perform the processes corresponding to the framework 500 as described above with reference to FIGS. 5 and 6.

Method 800 then proceeds to block 810 with generating, from a first neural implicit surface network, a first high-definition (HD) map comprising labels created from one or more characteristics corresponding to the first environment determined based on the first sensor data. For example, block 810 may be performed by the apparatus, such as a map collection vehicle 120 as described above with reference to FIGS. 3-4 and 10 that is configured to perform the processes corresponding to the framework 500 as described above with reference to FIGS. 5 and 6.

In certain aspects, the one or more characteristics comprise geometry information, appearance information, and semantic information corresponding to the first environment.

In certain aspects, generating the HD map at block 810 of method 800 further includes: determining, based on the first sensor data, the one or more characteristics; encoding, with the first neural implicit surface network, the one or more characteristics; generating, with the first neural implicit surface network, one or more predicted output modalities; rendering, based on the one or more predicted output modalities, one or more two-dimensional representations of the first environment, each of the one or more two-dimensional representations comprising respective per-pixel modality information; determining one or more losses corresponding to the one or more two-dimensional representations; and adjusting one or more weights of the first neural implicit surface network to reduce the one or more losses

In certain aspects, a first predicted output modality of the one or more predicted output modalities comprises a predicted signed distance to closest surfaces of the first environment represented by the one or more characteristics; and the one or more two-dimensional representations comprise a signed distance field based on the predicted signed distance to the closest surfaces.

In certain aspects, each of the plurality of sensors corresponding to a different perception modality and/or the one or more two-dimensional representations comprise a depth map.

In certain aspects, determining the one or more losses further includes determining a geometric loss between the first sensor data and the depth map.

In certain aspects, the first neural implicit surface network comprises a semantic head configured to generate a first predicted output modality of the one or more predicted output modalities, the first predicted output modality comprising semantic logits; and the one or more two-dimensional representations comprise a semantic segmentation map based on the semantic logits.

In certain aspects, the first sensor data comprises image data comprising a plurality of images and method 800 further includes receiving a set of semantic labels for a subset of images of the plurality of images and determining the one or more losses comprises determining a multi-class cross-entropy loss between the semantic segmentation map and the set of semantic labels

In certain aspects, method 800 further includes obtaining a viewing direction with respect to the first environment. The first neural implicit surface network may include a color head configured to generate a first predicted output modality of the one or more predicted output modalities. The first predicted output modality may include per-pixel color values corresponding to the viewing direction and the one or more two-dimensional representations may include a color map based on the per-pixel color values.

In certain aspects, the step of determining the one or more losses includes determining a photometric loss between a ground truth image and the color map.

In certain aspects, method 800 further includes receiving second sensor data comprising a second plurality of frames corresponding to a second environment, wherein the second sensor data is generated from the plurality of sensors; and generating from a second neural implicit surface network, a second HD map comprising second labels created from one or more second characteristics corresponding to the second environment determined based on the second sensor data. Furthermore, method 800 may include stitching a plurality of high definition maps comprising at least the first HD map and the second HD map to generate a global high-definition map

In certain aspects, method 800 further includes masking out dynamic objects from the first sensor data prior to generating the first HD map.

In certain aspects, the first sensor data is pairwise aligned and synchronized.

In certain aspects, method 800 further includes extracting a mesh model based on the first neural implicit surface network; selecting a first label from the labels, wherein the first label is associated with a bounding box corresponding to an object in the first environment; generating a candidate bounding box defined by a sub-mesh of the mesh model, wherein coordinates of the sub-mesh indicate the candidate bounding box and the candidate bounding box predicts a location and size of the object in the first environment; calculating a 3D intersection-over-union (IoU) value for the bounding box and the candidate bounding box; and generating an indication based on the 3D IoU value being less than a threshold value. The indication indicates an uncertainty regarding an accuracy of the first label within the first HD map for the object. In certain aspects, the indication comprises a location of the object in the first environment and method 800 further includes causing the apparatus to collect additional sensor data corresponding to the location of the object.

In certain aspects, method 800 further includes selecting a first label from the labels, wherein the first label is associated with a bounding box and an annotation corresponding to an object in the first environment; determining an amount of space occupied within the bounding box; determining that the amount of space is less than a predetermined threshold, the predetermined threshold corresponding to the annotation of the object; and generating an indication based on the amount of space being less than the predetermined threshold. The indication may include a location of the object in the first environment and method 800 may further include causing the apparatus to collect additional sensor data corresponding to the location of the object.

Note that FIG. 8 is just one example of a method, and other methods including fewer, additional, or alternative operations are possible consistent with this disclosure.

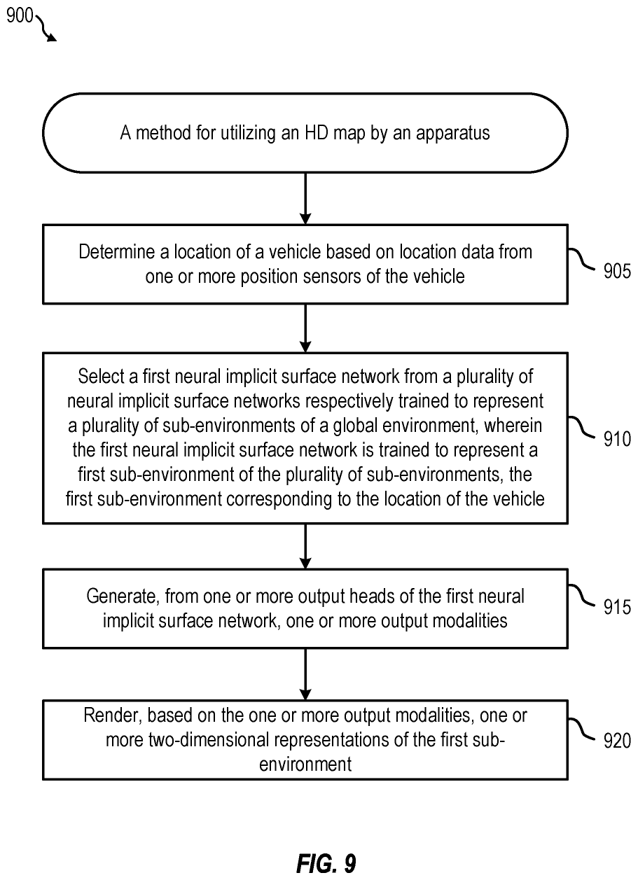

FIG. 9 shows a method 900 for utilizing an HD map generated by a neural implicit surface network by an apparatus, such as a map collection vehicle 120 of FIGS. 3-4 and 10.

Method 900 begins at block 905 with determining a location of a vehicle based on location data from one or more position sensors of the vehicle. For example, block 905 may be performed by the apparatus, such as a map collection vehicle 120 as described above with reference to FIGS. 3-4 and 10 that is configured to perform the processes corresponding to the framework 500 as described above with reference to FIGS. 5 and 6.

Method 900 then proceeds to block 910 with selecting a first neural implicit surface network from a plurality of neural implicit surface networks respectively trained to represent a plurality of sub-environments of a global environment, wherein the first neural implicit surface network is trained to represent a first sub-environment of the plurality of sub-environments, the first sub-environment corresponding to the location of the vehicle.

Method 900 then proceeds to block 915 with generating, from one or more output heads of the first neural implicit surface network, one or more output modalities.

Method 900 then proceeds to block 920 with rendering, based on the one or more output modalities, one or more two-dimensional representations of the first sub-environment.

In certain aspects, the one or more output heads comprise a signed distance head configured to generate a predicted signed distance to closest surfaces of the first sub-environment; and the one or more two-dimensional representations comprise a signed distance field based on the predicted signed distance to the closest surfaces of the first sub-environment.

In certain aspects, the one or more output heads comprise a semantic head configured to generate semantic logits; and the one or more two-dimensional representations comprise a semantic segmentation map based on the semantic logits.

In certain aspects, method 900 further includes causing the apparatus to receive a viewing direction with respect to the first sub-environment. The one or more output heads comprise a color head configured to generate per-pixel color values corresponding to the viewing direction. The one or more two-dimensional representations comprise a color map based on the per-pixel color values.

In certain aspects, the one or more two-dimensional representations comprise a depth map based on the one or more output modalities.

In certain aspects, method 900 further includes causing the apparatus to execute at least one of a perception, vehicle localization, or vehicle route planning operation based on the one or more two-dimensional representations of the first sub-environment.

Note that FIG. 9 is just one example of a method, and other methods including fewer, additional, or alternative operations are possible consistent with this disclosure.

### Example Apparatus

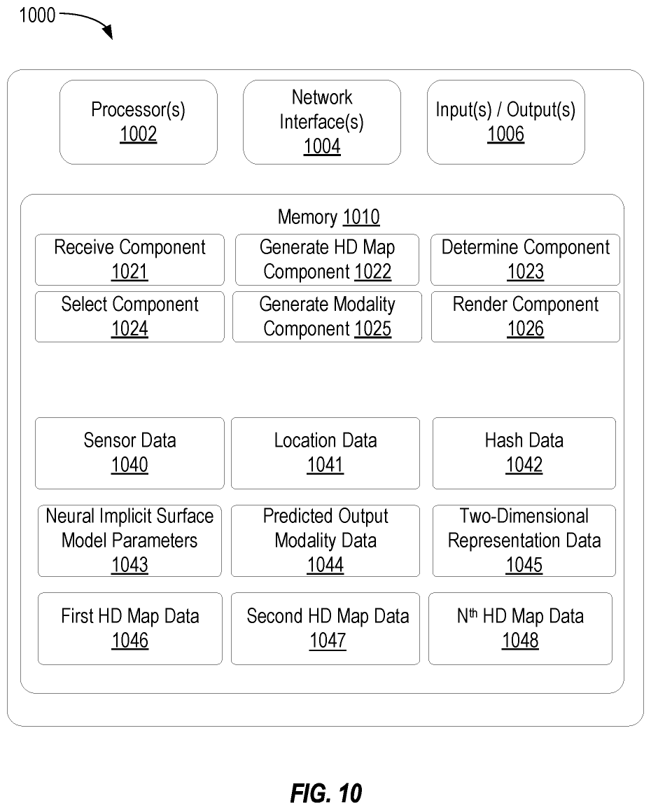

FIG. 10 depicts an apparatus 1000, such as computing device of a vehicle configured to perform the methods described herein. The apparatus 1000 may be the map collection vehicle 120 as described herein with reference to FIGS. 3-4.

Apparatus 1000 includes one or more processors 1002. Generally, processor(s) 1002 may be configured to execute computer-executable instructions (e.g., software code) to perform various functions, as described herein.

Apparatus 1000 further includes a network interface(s) 1004, which generally provides data access to any sort of data network, including personal area networks (PANs), local area networks (LANs), wide area networks (WANs), the Internet, and the like.

Apparatus 1000 further includes input(s) and output(s) 1006, which generally provide means for providing data to and from apparatus 1000, such as via connection to computing device peripherals, including user interface peripherals.

Apparatus 1000 further includes a memory 1010 configured to store various types of components and data.

In this example, memory 1010 includes a receive component 1021, a generate HD map component 1022, a determine component 1023, a select component 1024, a generate modality component 1025, and a render component 1026.

The receive component 1021 is configured to perform processes corresponding to receiving sensor data from the plurality of sensors, for example as depicted and described with reference to blocks 501 and 510 of FIG. 5 and block 805 of method 800 depicted and described with reference to FIG. 8.

The generate HD map component 1022 is configured to perform processes corresponding to generating the HD map, for example as depicted and described with reference to blocks 520, 530, 540, 550, and 580 of FIG. 5 and block 810 of method 800 depicted and described with reference to FIG. 8.

The determine component 1023 is configured to perform processes corresponding to determining a location of a vehicle, for example as depicted and described with reference to reference to FIGS. 5 and 6 and at least block 905 of method 900 depicted and described with reference to FIG. 9.

The select component 1024 is configured to perform processes corresponding to selecting a neural implicit surface model based on the location of the vehicle, for example as depicted and described with reference to FIGS. 5 and 6 and at least block 910 of method 900 depicted and described with reference to FIG. 9.

The generate modality component 1025 is configured to perform processes corresponding to generating an output modality, for example as depicted and described with reference to FIGS. 5 and 6 and at least block 915 of method 900 depicted and described with reference to FIG. 9.

The render component 1026 is configured to perform processes corresponding to rendering a two-dimensional representation of an environment, for example as depicted and described with reference to FIGS. 5 and 6 and at least block 920 of method 900 depicted and described with reference to FIG. 9.

In this example, memory 1010 also includes sensor data 1040, location data 1041, hash data 1042, neural implicit surface model parameters 1043, predicted output modality data 1044, two-dimensional representation data 1045, first HD map data 1046, second HD map data 1047, and Nth HD map data 1048.

Sensor data 1040 may correspond to the sensor data 502 obtained from the sensors. Location data 1041 may correspond to position information obtained from the sensor data 502. Hash data 1042 may correspond to the feature vectors and related data generated by the processes implemented at the hash block 510 as depicted and described with reference to FIG. 5. Neural implicit surface model parameters 1043 may correspond to the neural network 520, trained or untrained, including the weights and layers defining the neural network 520 and/or the one or more output heads 530 of the neural network 520.

Predicted output modality data 1044 may correspond to the data output by the one or more output heads 530 and utilized by the rendering block 540 as depicted and described with reference to FIG. 5. The two-dimensional representation data 1045 may correspond to the two-dimensional representations generated 550 as depicted and described with reference to FIG. 5. The first HD map data 1046, the second HD map data 1047, and the Nth HD map data 1048 may each correspond to HD maps generated for a sub-environment or ones stitched together for a global environment as depicted and described herein.

Apparatus 1000 may be implemented in various ways. For example, apparatus 1000 may be implemented within on-site, remote, or cloud-based processing equipment.

Apparatus 1000 is just one example, and other configurations are possible. For example, in alternative aspects, aspects described with respect to apparatus 1000 may be omitted, added, or substituted for alternative aspects.

### EXAMPLE CLAUSES

Implementation examples are described in the following numbered clauses:
Clause 1: A method comprising receiving first sensor data comprising a plurality of frames corresponding to a first environment, wherein the first sensor data is generated from a plurality of sensors; and generating, from a first neural implicit surface network, a first high-definition (HD) map comprising labels created from one or more characteristics corresponding to the first environment determined based on the first sensor data.
Clause 2: The method of Clause 1, wherein the one or more characteristics comprise geometry information, appearance information, and semantic information corresponding to the first environment.
Clause 3: The method of any one of Clauses 1-2, wherein generating the HD map comprises: determining, based on the first sensor data, the one or more characteristics; encoding, with the first neural implicit surface network, the one or more characteristics; generating, with the first neural implicit surface network, one or more predicted output modalities; rendering, based on the one or more predicted output modalities, one or more two-dimensional representations of the first environment, each of the one or more two-dimensional representations comprising respective per-pixel modality information; determining one or more losses corresponding to the one or more two-dimensional representations; and adjusting one or more weights of the first neural implicit surface network to reduce the one or more losses.
Clause 4: The method of Clause 3, wherein: a first predicted output modality of the one or more predicted output modalities comprises a predicted signed distance to closest surfaces of the first environment represented by the one or more characteristics; and the one or more two-dimensional representations comprise a signed distance field based on the predicted signed distance to the closest surfaces.
Clause 5: The method of Clause 3, wherein each of the plurality of sensors corresponding to a different perception modality.
Clause 6: The method of Clause 3, wherein the one or more two-dimensional representations comprise a depth map.
Clause 7: The method of Clause 6, wherein determining the one or more losses comprises determining a geometric loss between the first sensor data and the depth map.
Clause 8: The method of Clause 3, wherein: the first neural implicit surface network comprises a semantic head configured to generate a first predicted output modality of the one or more predicted output modalities, the first predicted output modality comprising semantic logits; and the one or more two-dimensional representations comprise a semantic segmentation map based on the semantic logits.
Clause 9: The method of Clause 8, wherein: the first sensor data comprises image data comprising a plurality of images; and further comprising receiving a set of semantic labels for a subset of images of the plurality of images; and determining the one or more losses comprises to determine a multi-class cross-entropy loss between the semantic segmentation map and the set of semantic labels.
Clause 10: The method of Clause 3, further comprising obtaining a viewing direction with respect to the first environment; wherein the first neural implicit surface network comprises a color head configured to generate a first predicted output modality of the one or more predicted output modalities, the first predicted output modality comprising per-pixel color values corresponding to the viewing direction, and the one or more two-dimensional representations comprise a color map based on the per-pixel color values.
Clause 11: The method of Clause 10, wherein determining the one or more losses comprises determining a photometric loss between a ground truth image and the color map.
Clause 12: The method of any one of Clauses 1-10, further comprising: receiving second sensor data comprising a second plurality of frames corresponding to a second environment, wherein the second sensor data is generated from the plurality of sensors; and generating from a second neural implicit surface network, a second HD map comprising second labels created from one or more second characteristics corresponding to the second environment determined based on the second sensor data.
Clause 13: The method of Clause 12, further comprising stitching a plurality of high definition maps comprising at least the first HD map and the second HD map to generate a global high-definition map.
Clause 14: The method of any one of Clauses 1-13, further comprising masking out dynamic objects from the first sensor data prior to generating the first HD map.
Clause 15: The method of any one of Clauses 1-14, wherein the first sensor data is pairwise aligned and synchronized.
Clause 16: The method of any one of Clauses 1-15, further comprising: extracting a mesh model based on the first neural implicit surface network; selecting a first label from the labels, wherein the first label is associated with a bounding box corresponding to an object in the first environment; generating a candidate bounding box defined by a sub-mesh of the mesh model, wherein coordinates of the sub-mesh indicate the candidate bounding box and the candidate bounding box predicts a location and size of the object in the first environment; calculating a 3D intersection-over-union (IoU) value for the bounding box and the candidate bounding box; and generating an indication based on the 3D IoU value being less than a threshold value.
Clause 17: The method of Clause 16, wherein the indication indicates an uncertainty regarding an accuracy of the first label within the first HD map for the object.
Clause 18: The method of Clause 16, wherein: the indication comprises a location of the object in the first environment; and further comprising collecting additional sensor data corresponding to the location of the object.
Clause 19: The method of any one of Clauses 1-18, further comprising: selecting a first label from the labels, wherein the first label is associated with a bounding box and an annotation corresponding to an object in the first environment; determining an amount of space occupied within the bounding box; determining that the amount of space is less than a predetermined threshold, the predetermined threshold corresponding to the annotation of the object; and generating an indication based on the amount of space being less than the predetermined threshold.
Clause 20: The method of Clause 19, wherein the indication comprises a location of the object in the first environment; and further comprising collecting additional sensor data corresponding to the location of the object.
Clause 21: A method, comprising: determining a location of a vehicle based on location data from one or more position sensors of the vehicle; selecting a first neural implicit surface network from a plurality of neural implicit surface networks respectively trained to represent a plurality of sub-environments of a global environment, wherein the first neural implicit surface network is trained to represent a first sub-environment of the plurality of sub-environments, the first sub-environment corresponding to the location of the vehicle; generating, from one or more output heads of the first neural implicit surface network, one or more output modalities; and rendering, based on the one or more output modalities, one or more two-dimensional representations of the first sub-environment.
Clause 22: The method of Clause 21, wherein: the one or more output heads comprise a signed distance head configured to generate a predicted signed distance to closest surfaces of the first sub-environment; and the one or more two-dimensional representations comprise a signed distance field based on the predicted signed distance to the closest surfaces of the first sub-environment.
Clause 23: The method of Clause 21, wherein: the one or more output heads comprise a semantic head configured to generate semantic logits; and the one or more two-dimensional representations comprise a semantic segmentation map based on the semantic logits.
Clause 24: The method of Clause 21, further comprising: receiving a viewing direction with respect to the first sub-environment; wherein the one or more output heads comprise a color head configured to generate per-pixel color values corresponding to the viewing direction; and the one or more two-dimensional representations comprise a color map based on the per-pixel color values.
Clause 25: The method of Clause 21, wherein the one or more two-dimensional representations comprise a depth map based on the one or more output modalities.
Clause 26: The method of Clause 21, further comprising executing at least one of a perception, vehicle localization, or vehicle route planning operation based on the one or more two-dimensional representations of the first sub-environment.
Clause 27: One or more apparatuses, comprising: one or more memories and one or more processors, coupled to the one or more memories, configured to cause the apparatus to perform a method in accordance with any one of Clauses 1-26.
Clause 28: One or more apparatuses, comprising means for performing a method in accordance with any one of Clauses 1-26.
Clause 29: One or more non-transitory computer-readable media comprising executable instructions that, when executed by one or more processors of one or more apparatuses, cause the one or more apparatuses to perform a method in accordance with any one of Clauses 1-26.
Clause 30: One or more computer program products embodied on one or more computer-readable storage media comprising code for performing a method in accordance with any one of Clauses 1-26

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus, comprising:
one or more memories; and
one or more processors, coupled to the one or more memories, configured to cause the apparatus to:
receive first sensor data comprising a plurality of frames corresponding to a first environment, wherein the first sensor data is generated from a plurality of sensors; and
generate, from a first neural implicit surface network, a first high-definition (HD) map comprising labels created from one or more characteristics corresponding to the first environment determined based on the first sensor data.

2. The apparatus of claim 1, wherein the one or more characteristics comprise geometry information, appearance information, and semantic information corresponding to the first environment.

3. The apparatus of claim 1, wherein to generate the first HD map comprises to:
determine, based on the first sensor data, the one or more characteristics;
encode, with the first neural implicit surface network, the one or more characteristics;
generate, with the first neural implicit surface network, one or more predicted output modalities;
render, based on the one or more predicted output modalities, one or more two-dimensional representations of the first environment, each of the one or more two-dimensional representations comprising respective per-pixel modality information;
determine one or more losses corresponding to the one or more two-dimensional representations; and
adjust one or more weights of the first neural implicit surface network to reduce the one or more losses.

4. The apparatus of claim 3, wherein:
a first predicted output modality of the one or more predicted output modalities comprises a predicted signed distance to closest surfaces of the first environment represented by the one or more characteristics; and
the one or more two-dimensional representations comprise a signed distance field based on the predicted signed distance to the closest surfaces.

5. The apparatus of claim 3, wherein each of the plurality of sensors corresponding to a different perception modality.

6. The apparatus of claim 3, wherein the one or more two-dimensional representations comprise a depth map.

7. The apparatus of claim 6, wherein to determine the one or more losses comprises to determine a geometric loss between the first sensor data and the depth map.

8. The apparatus of claim 3, wherein:
the first neural implicit surface network comprises a semantic head configured to generate a first predicted output modality of the one or more predicted output modalities, the first predicted output modality comprising semantic logits; and
the one or more two-dimensional representations comprise a semantic segmentation map based on the semantic logits.

9. The apparatus of claim 8, wherein:
the first sensor data comprises image data comprising a plurality of images;
the one or more processors are configured to further cause the apparatus to receive a set of semantic labels for a subset of images of the plurality of images; and
to determine the one or more losses comprises to determine a multi-class cross-entropy loss between the semantic segmentation map and the set of semantic labels.

10. The apparatus of claim 3, wherein:
the one or more processors are configured to further cause the apparatus to obtain a viewing direction with respect to the first environment;
the first neural implicit surface network comprises a color head configured to generate a first predicted output modality of the one or more predicted output modalities, the first predicted output modality comprising per-pixel color values corresponding to the viewing direction, and
the one or more two-dimensional representations comprise a color map based on the per-pixel color values.

11. The apparatus of claim 10, wherein to determine the one or more losses comprises to determine a photometric loss between a ground truth image and the color map.

12. The apparatus of claim 1, wherein the one or more processors are configured to further cause the apparatus to:
receive second sensor data comprising a second plurality of frames corresponding to a second environment, wherein the second sensor data is generated from the plurality of sensors; and
generate from a second neural implicit surface network, a second HD map comprising second labels created from one or more second characteristics corresponding to the second environment determined based on the second sensor data.

13. The apparatus of claim 12, wherein the one or more processors are configured to further cause the apparatus to stitch a plurality of high definition maps comprising at least the first HD map and the second HD map to generate a global high-definition map.

14. The apparatus of claim 1, wherein the one or more processors are configured to further cause the apparatus to mask out dynamic objects from the first sensor data prior to generating the first HD map.

15. The apparatus of claim 1, wherein the first sensor data is pairwise aligned and synchronized.

16. The apparatus of claim 1, wherein the one or more processors are configured to further cause the apparatus to:
extract a mesh model based on the first neural implicit surface network;
select a first label from the labels, wherein the first label is associated with a bounding box corresponding to an object in the first environment;
generate a candidate bounding box defined by a sub-mesh of the mesh model, wherein coordinates of the sub-mesh indicate the candidate bounding box and the candidate bounding box predicts a location and size of the object in the first environment;
calculate a 3D intersection-over-union (IoU) value for the bounding box and the candidate bounding box; and
generate an indication based on the 3D IoU value being less than a threshold value.

17. The apparatus of claim 16, wherein the indication indicates an uncertainty regarding an accuracy of the first label within the first HD map for the object.

18. The apparatus of claim 16, wherein:
the indication comprises a location of the object in the first environment; and
the one or more processors are configured to further cause the apparatus to collect additional sensor data corresponding to the location of the object.

19. The apparatus of claim 1, wherein the one or more processors are configured to further cause the apparatus to:
select a first label from the labels, wherein the first label is associated with a bounding box and an annotation corresponding to an object in the first environment;
determine an amount of space occupied within the bounding box;
determine that the amount of space is less than a predetermined threshold, the predetermined threshold corresponding to the annotation of the object; and
generate an indication based on the amount of space being less than the predetermined threshold.

20. The apparatus of claim 19, wherein:
the indication comprises a location of the object in the first environment; and
the one or more processors are configured to further cause the apparatus to collect additional sensor data corresponding to the location of the object.

21. An apparatus, comprising:
one or more memories; and
one or more processors, coupled to the one or more memories, configured to cause the apparatus to:
determine a location of a vehicle based on location data from one or more position sensors of the vehicle;
select a first neural implicit surface network from a plurality of neural implicit surface networks respectively trained to represent a plurality of sub-environments of a global environment, wherein the first neural implicit surface network is trained to represent a first sub-environment of the plurality of sub-environments, the first sub-environment corresponding to the location of the vehicle;
generate, from one or more output heads of the first neural implicit surface network, one or more output modalities; and
render, based on the one or more output modalities, one or more two-dimensional representations of the first sub-environment.

22. The apparatus of claim 21, wherein:
the one or more output heads comprise a signed distance head configured to generate a predicted signed distance to closest surfaces of the first sub-environment; and
the one or more two-dimensional representations comprise a signed distance field based on the predicted signed distance to the closest surfaces of the first sub-environment.

23. The apparatus of claim 21, wherein:
the one or more output heads comprise a semantic head configured to generate semantic logits; and
the one or more two-dimensional representations comprise a semantic segmentation map based on the semantic logits.

24. The apparatus of claim 21, wherein:
the one or more processors are configured to further cause the apparatus to receive a viewing direction with respect to the first sub-environment;
the one or more output heads comprise a color head configured to generate per-pixel color values corresponding to the viewing direction; and
the one or more two-dimensional representations comprise a color map based on the per-pixel color values.

25. The apparatus of claim 21, wherein the one or more two-dimensional representations comprise a depth map based on the one or more output modalities.

26. The apparatus of claim 21, wherein the one or more processors are configured to further cause the apparatus to execute at least one of a perception, vehicle localization, or vehicle route planning operation based on the one or more two-dimensional representations of the first sub-environment.

27. A method, comprising:
receiving first sensor data comprising a plurality of frames corresponding to a first environment, wherein the first sensor data is generated from a plurality of sensors; and
generating, from a first neural implicit surface network, a first high-definition (HD) map comprising labels created from one or more characteristics corresponding to the first environment determined based on the first sensor data.

28. A method, comprising:
determining a location of a vehicle based on location data from one or more position sensors of the vehicle;
selecting a first neural implicit surface network from a plurality of neural implicit surface networks respectively trained to represent a plurality of sub-environments of a global environment, wherein the first neural implicit surface network is trained to represent a first sub-environment of the plurality of sub-environments, the first sub-environment corresponding to the location of the vehicle;
generating, from one or more output heads of the first neural implicit surface network, one or more output modalities; and
rendering, based on the one or more output modalities, one or more two-dimensional representations of the first sub-environment.
